(19) United States
(12) Patent Application Publication
(10) Pub. No.: US 2010/0038021 A1
(43) Pub. Date: Feb. 18, 2010

(54) DEVICE AND METHOD FOR APPLYING DECORATION, WHICH ADHERES TO A FILM, TO A MULTIDIMENTIONAL OBJECT

(76) Inventor: Maximilian Zaher, Edewecht (DE)

Correspondence Address: STRAUB & POKOTYLO, 788 Shrewsbury Avenue, TINTON FALLS, NJ, 07724, US

(21) Appl. No.: 12/593,276

(22) PCT Filed: Mar. 26, 2007
(86) PCT No.: PCT/EP2007/002659

§ 371 Date: Oct. 12, 2009

(51) Int. Cl. B44C 1/16; B44C 1/18

(52) U.S. Cl. 156/235; 156/584; 156/380.9

(57) ABSTRACT

The invention relates to a device and a method for applying decoration, which adheres to a film (1), to at least two sides (2a, 2b) of a multidimensional object (2). The device has means for detaching parts of the decoration from the film (1) onto a first side (2a) of the object, means (17) for adapting the film (1) to a second side (2b) of the object, the means for adapting being arranged, in the running direction of the film (1), following the means for detaching parts of the decoration from the film (1) onto a first side (2a) of the object, and means (12, 13) for detaching parts of the decoration from the film (1), adapted to the second side (2b) of the object, onto the second side (2b) of the object.

The present invention relates to a device and a method for applying decoration, which adheres to a film, to at least two sides of a multidimensional object, and to a device and a method for applying decoration, which adheres to a film, to at least a second side of a multidimensional object, parts of the decoration having already been applied to a first side of the object.

Films which have a so-called release property are known from the prior art, for example the patent specifications EP 0 573 676 B1 and EP 1 053 793 A1. Both papers and films which have been produced from resins and the surfaces of which have been treated such that the film or paper has release properties are known from the prior art. If a layer of lacquer or decorative layer with release properties is applied to such a film, these can be detached onto an object to be decorated.

The document EP 0 573 676 B1 discloses the use of a carrier with a release property for applying colour decoration to a substrate. For this purpose, first lacquer and optionally dyestuff is applied to a carrier with a release property. Then, a partial crosslinking of the lacquer is carried out. Subsequently, the partially crosslinked lacquer, with or without the dyestuff, is transferred to the substrate to be decorated or lacquerer and complete crosslinking of the lacquer takes place.

The document EP 1 053 793 A1 discloses a process for applying lacquer and decoration to an object with the aid of a film which has a release property, an adhesive layer being applied to the lacquer and the decoration of the release film. When the layers are applied to the object, the adhesive layer is in direct contact with the object.

A device for applying decoration, which adheres to a film, to two sides of an object with the aid of the release technique is also known from the prior art. However, the known device has the disadvantage that a separate film must be used for each side of the object to be printed.

Against this background, it is an object of the present invention to provide a device and a method for applying decoration, which adheres to a film, to at least two sides of a multidimensional object which enable machine printing of two sides of the object by the release technique with only one film.

This object is achieved by a device of the type referred to at the outset, which has means for detaching the decoration from the film and transferring the decoration onto a first side of the object, means for adapting the film to a second side of the object, the means for adapting being arranged, in the running direction of the film, following the means for detaching parts of the decoration from the film onto a first side of the object, and means for detaching parts of the decoration from the film, adapted to the second side of the object, onto the second side of the object.

The object is also achieved by a device of the type referred to at the outset, in which parts of the decoration having already been applied to a first side of the object, the device having means for adapting the film to a second side of the object and means for detaching parts of the decoration from the film, adapted to the second side of the object, onto the second side of the object.

A main idea of the present invention is to print, with the aid of only one film, at least two sides of an object with a decoration with the aid of the release technique. The film is preferably a film with release properties. The decoration in this case adheres to the film.

In a first step, with the aid of the means for detaching parts of the decoration from the film and applying the same to a first side of the object, parts of the decoration are detached onto the first side of the object. After passing the means for detaching parts of the decoration from the film onto a first side of the object, a part of the decoration is situated on the first side of the object, whereas a further part of the decoration still adheres to the film. Following the means for detaching parts of the decoration from the film and transferring them onto a first side of the object, the film passes means for adapting the film to a second side of the object. These means for adapting the film to a second side of the object are arranged, in the running direction of the film, following the means for detaching parts of the decoration from the film onto a first side of the object. With the aid of the means for adapting the film to a second side of the object, the part of the film to which decoration still adheres is adapted to the second side of the object and thus prepared for detaching further parts of the decoration from the film onto the second side of the object. After passing the means for adapting the film to a second side of the object, the remaining part of the decoration is applied to the second side of the object with the aid of following means for detaching parts of the decoration from the film, adapted to the second side of the object, onto the second side of the object. The invention is, however, not restricted to two sides of an object which are to be printed. Thus, it is conceivable for further sides of the object to be printed in analogous fashion with decoration which is still situated in the film.

In an advantageous embodiment variant of the invention, the means for detaching parts of the decoration from the film adapted to the second side of the object are designed so as to be movable in at least two directions, preferably three directions. Preferably, the means for detaching parts of the decoration from the film adapted to the second side of the object are in this case movable upwards and downwards, an angle of inclination is adjustable and the means can be pressed against the second side of the object to be printed. With the aid of the movability, according to the invention, of the means for detaching parts of the decoration from the film adapted to the second side of the object in three directions, it is possible to adapt the device flexibly and easily to objects designed with different geometries. Thus, for example, it is easily possible to switch from an edge of an object departing at a right angle to an edge departing at a 130° angle.

With regard to the means for detaching parts of the decoration from the film adapted to the second side of the object, an advantageous embodiment variant of the invention provides that these means have a profiled detaching roller for detaching the decoration from the film onto the object and means for heating the detaching roller. With the aid of the profiled detaching roller, the decoration is detached from the film by the release technique and applied to the object.

For the release technique, it is beneficial for the detaching roller to be heated. According to an advantageous development of the invention, in the case of the means for heating the detaching roller the temperature is variably adjustable. The temperature for the release technique should be variably adjustable in order that the device can be adapted to different materials of the object. In particular, the possibility of a quick temperature change is advantageous if a change of the film is to be made for objects which remain the same.

According to a preferred embodiment of the invention, the means for heating the detaching roller have at least one infrared radiator. A heating of the detaching roller with the aid of infrared radiators has the advantage over a known heating with the aid of circulating air that less energy is required.

Preferably, the means for heating the detaching roller supply a temperature of 80° C. to 240° C. to which the detaching roller is heated. With the aid of infrared radiators, such temperatures can be easily provided, with infrared radiators having the additional advantage that the temperature is variably and stably adjustable.

In the case of an advantageous embodiment of the invention, it is further provided that the means for heating the detaching roller are arranged over an area of the surface of the detaching roller which is defined by a circular arc of the detaching roller with a central angle of at least 160° and the width of the detaching roller. In the case of the embodiment of the means for heating the detaching roller by infrared radiators, this would mean that a large number of infrared radiators are arranged over the surface of the detaching roller. It is, however, also conceivable for only one infrared radiator configured in a circular-arc shape to be used. In principle, it can be said that the greater the area irradiated by the means for heating the detaching roller, the more favourable are the results achieved in the case of the release technique. This also means that at higher temperatures of the film higher throughput speeds of the film through the device can be attained. Good results have been achieved with a central angle of at least 160°. Preferably, the central angle is 180°.

According to a preferred embodiment of the invention, the detaching roller consists of silicone at least at the surface. Silicone has the property of being heat-resistant and yet having a high stiffness, for example a higher stiffness than silicone foam. Silicone is well suited to absorbing the heat from the means for heating the detaching roller and, as a result of pressure, releasing the decoration from the film with the aid of the release technique and applying it to the second side of the object.

In an advantageous embodiment of the invention, the means for adapting the film to a second side of the object have at least one adapting roller. With the aid of the adapting roller, the film is prepared for detaching the decoration onto the second side of the object with the aid of the means for detaching parts of the decoration from the film adapted to the second side of the object. The adapting roller in this case bends or folds the film in the direction of the second side of the object. What is important is that the adapting roller adapts the film to the second side of the object in such a way that the remaining decoration can be subsequently applied from the film to the second side of the object with the aid of the release technique.

With regard to the object stated at the outset, the method of the type referred to at the outset is characterised by the method steps of detaching parts of the decoration from the film onto a first side of the object, adapting the film to a second side of the object, and detaching parts of the decoration from the film, adapted to the second side of the object, onto the second side of the object.

The present invention also relates to a method for applying decoration, which adheres to a film, to at least a second side of the multidimensional object, in which parts of the decoration have already been applied to a first side of the object, having at least the method steps of adapting the film to a second side of the object, and detaching parts of the decoration from the film, adapted to the second side of the object, and transferring them onto the second side of the object.

The invention is explained below by way of example with reference to the accompanying figures, in which:

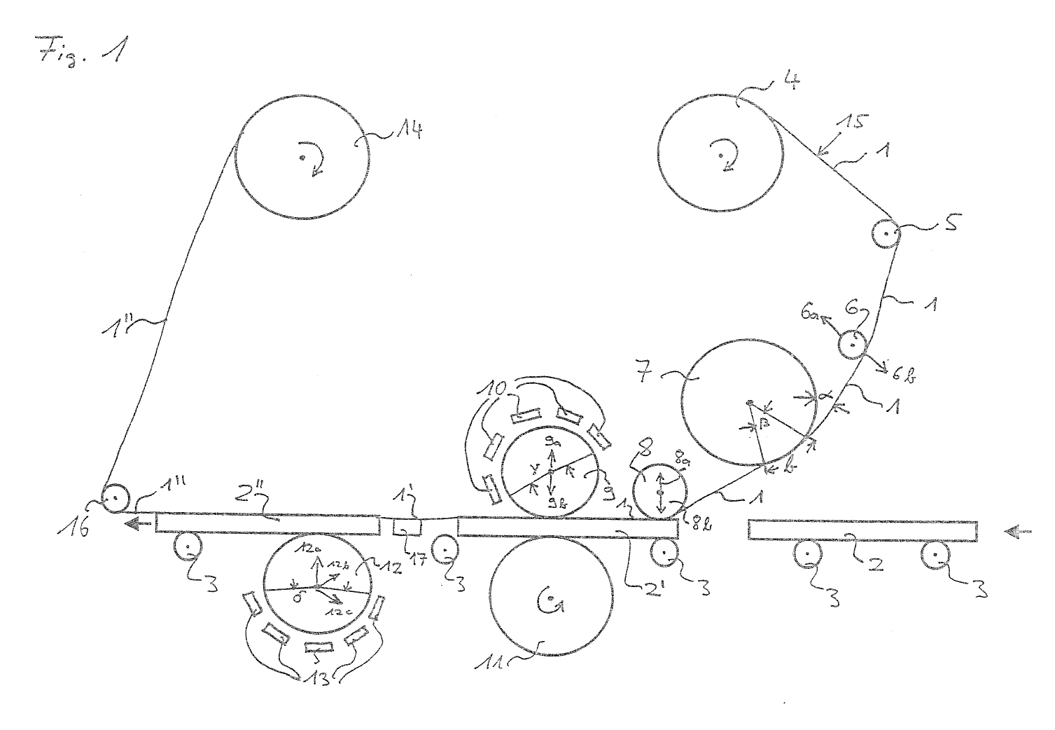

FIG. 1 shows a schematic lateral representation of a device for applying decoration, which adheres to a film, to two sides of a multidimensional object,

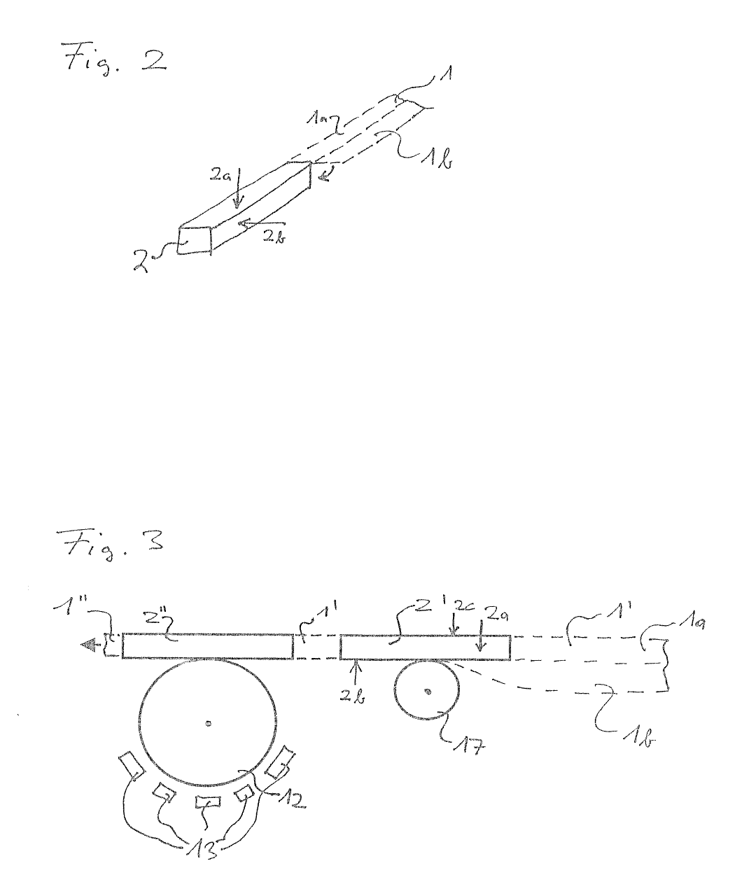

FIG. 2 shows a three-dimensional representation of an object to be printed together with the associated film, and

FIG. 3 shows a detailed schematic view from above of a device for applying decoration, which adheres to a film, to a second side of an object.

In the case of the device shown in FIG. 1, a film 1 with release properties passes through a device for applying decoration, which adheres to a film, to a multidimensional object 2. According to preferred embodiment, the film is a so-called sandwich structure consisting of two polypropylene layers and a layer made of polypropylene foam lying therebetween. The sandwich structure is preferably produced with the aid of a coextrusion process. The film has a thickness of 50 μm, and can have a width of up to 50 cm. The construction of the film from polypropylene and polypropylene foam has the advantage that even at high throughput speeds through the device the film does not crease, and is nevertheless flexible.

For the release technique, use is preferably made of polypropylene, since polypropylene has a poor adhesive property and thus decoration or a colour layer can be easily detached from the film. Owing to the poor adhesive property, however, it is difficult to apply decoration to the film. For this reason, the outer polypropylene layer of the film is subjected to a corona treatment in order to apply the decoration to the film. As a result of the corona treatment, the decoration adheres to the film, but can be detached from the film again by means of the release technique and thereby applied to the object. Preferably, the corona treatment is carried out with a surface tension energy on the surface of the film of 35 to 45 dynes. A surface tension energy of 38 dynes yields advantageous adhesive properties. As a result of such a controlled corona treatment, the film can be printed with the decoration, but the decoration still remains detachable by the release technique.

As can be seen in FIG. 1, the film 1 is would on a winding-off roller 4. The winding-off roller 4 is mounted so as to be rotatable clockwise. The film 1 situated on the winding-off roller 4 has a decoration or a colour layer on the side 15. Optionally, a layer of lacquer (not shown) can be additionally arranged on the decoration or the colour layer. After being wound off from the winding-off roller 4, the film 1 runs over a deflection roller 5, which leads the film 1 to the adjusting roller 6. In doing so, the deflection roller 5 leads the film away from the winding-off roller 4. As can be seen in FIG. 1, the adjusting roller 6 is mounted so as to be movable in two directions 5A and 6B. The adjusting roller 6 consists of metal. After the film 1 has run over the adjusting roller 6, it is fed to the heating roller 7. By movement of the adjusting roller 6 in the directions 6A or 6B, the area of contact of the film 1 with the heating roller 7 can be adjusted. If, for example, the adjusting roller 6 is moved in the direction 6A, the area of contact b of the film 1 with the heating roller 7 is increased. If, however, the adjusting roller 6 is moved in the direction 6B, the size of the area of contact b of the film 1 with the heating roller 7 is reduced. By movement of the adjusting roller 6, the angle α is consequently reduced or increased, which results in a change of the central angle β of the contact area b. It is also conceivable for the adjusting roller 6 to be designed in such a way that it is movable in further directions in the plane of the figure. What is important is that the adjusting roller 6 is a means for adjusting the area of contact b of the film 1 with the heating roller 6.

The heating roller 7 is fixedly arranged in the embodiment according to FIG. 1. It consists of metal and has a hollow interior space (not shown). The heating roller 7 is heated with the aid of oil heating, the heating roller producing a temperature of 120° to 240°, preferably 180° C., on the film. Preferably, oil is used to heat the heating roller 7, since oil changes its temperature only very slowly.

After passing the heating roller 7, the film 1 is fed to the preforming roller 8. The preforming roller 8 consists of silicone foam at the surface. The preforming roller 8 is mounted so as to be movable in two directions 8A and 8B and has a negative profile of the object 2 to be printed. The purpose of the preforming roller is to prepare the film 1 for the release process, so that the film 1 does not crease or shrink even at high throughput speed of the film. At the preforming roller 8, the film 1 comes into contact for the first time with the first side of the object 2 to be printed. In the embodiment shown, a panel made of plastic is to be printed with a wood decoration on two sides. The object 2 to be printed may, however, be of all kinds and shapes of materials. The object 2 is led through the device and brought into contact with the film 1 via feed rollers 3. The object 2 is additionally supported in the device by lateral rollers (not shown). After passing the preforming roller 8, the film 1 is fed to the profile, detaching roller 9.

The profiled detaching roller 9 is mounted so as to be movable in two directions 9A and 9B. It consists of silicone at the surface and has at the surface a negative profile of the object 2 to be printed. The profiled detaching roller 9 is heated with the aid of five infrared radiators 10. The infrared radiators 10 are arranged over a region oil the surface of the profiled detaching roller 9 which is defined by the central angle γ. In principle, it is advantageous to heat as large a region of the surface of the detaching roller 9 as possible. With the aid of the heated silicone layer of the detaching roller 9 and the pressure exerted on the film 1 and the object 2 by the detaching roller 9, the decoration, or the decoration and the layer of lacquer, is detached from the film 1 and transferred onto the first side of the object 2 with the aid of the release technique. After passing the profiled detaching roller 9, parts of the decoration are no longer situated on the film 1′ but on the first side of the object 2′. Remaining parts of the decoration which are required for the printing of the second side of the object 2′ are still situated on the film 1′.

For machine transportation of the film 1, 1′ and of the object 2, 2′, 2″, the device has a drive roller 11. The drive roller 11 rotates anticlockwise and is operated with the aid of an electric motor. The rotational speed of the electric motor or the drive roller 11 is variably adjustable. It is thereby possible to control the throughput speed of the film 1, 1′, 1″ and of the object 2, 2′, 2″, depending on the material properties of the film 1, 1′, 1″ and of the objects 2, 2′, 2″, the area of contact b of the film 1 with the heating roller 7 and the temperatures of the heating roller 7 and of the detaching roller 9. The drive roller 11 and the detaching roller 9 can be coupled via a belt (not shown), so that the detaching roller 9 can be driven with the aid of the drive roller 11 via the belt.

After passing the detaching roller 9, a part of the decoration has thus been applied from the film 1 to the first side of the object 2′ with the aid of the release technique. The further part of the film 1 is subsequently adapted with the aid of the adapting roller 17 to the second side of the object 2′ to be printed. For this purpose, the film 1′ is folded laterally downwards and pressed onto the second side of the object 2′ with the aid of the adapting roller 17.

The object 2′, to which parts of the decoration have already been applied on the first side, and the film 1′, are subsequently fed to the detaching roller 12. The detaching roller is designed so as to be movable in the three directions 12A, 12B and 12C. Preferably, the detaching roller is movable upwards and downwards, a setting angle can be adjusted and for fine adjustment the detaching roller 12 can be pressed against the object 2′ to be printed. The detaching roller 12 has at its surface a negative profile of the second side of the object 2″ to be printed. This negative profile ensures that the decoration can be applied as desired to the second side of the object 2″.

The detaching roller 12 is heated with the aid of five infrared radiators 13. Infrared radiators have the advantage that the temperature can be adjusted quickly and variably. It may be possible, for example, that panels are to be printed with different decorations. In this case, the films are exchanged, but the panels to be printed remain the same. With the aid of the infrared radiators, it is possible to change the temperature variably without having to exchange the radiation source. This has economic advantages particularly in the case of machine processing.

The infrared radiators are arranged over the surface of the detaching roller 12 and irradiate a surface of the detaching roller 12 which is defined by the central angle δ and the width of the detaching roller. The central angle δ is preferably greater than 160°. The central angle δ is ideally 180°. If it is possible in terms of space to irradiate an even larger part of the surface of the detaching roller 12, this affords further advantages.

The detaching roller is preferably irradiated by the infrared radiators at a temperature of 80° C. to 210° C.

With the aid of the detaching roller 12 and the infrared radiators 13, it is thus possible to print additionally a second side of an object 2′ with decoration using only a single film 1′. This has the advantage over a solution with at least two films that the film can pass through the device at a high speed, i.e. of 5 to 45 m/min, and nevertheless decoration can be applied as desired to at least two sides of the object.

Since the width of the film can be up to 60 cm according to the invention, it is also possible for more than two sides of an object to be printed with a decoration with the aid of the release technique. With the aid of the present invention, it is also possible to print sharp edges of an object with decoration with the aid of only one film. In this case, according to the invention, no adhesive or adhesive layer is required on the decoration. With sharp edges, instead of a film made of polypropylene and polypropylene foam, polyethylene may also be used, since polyethylene is more flexible than polypropylene.

After passing detaching roller 12, the object 2′ has been printed with decoration on two sides as desired and passes over the roller 3 out of the device, as indicated by the arrow. The film 1″, which has no more decoration after passing the detaching roller 12, is deflected via a deflection roller 16 and fed to the winding-up roller 14. After passage of the film through the device according to the invention, the wound-up film 1″, to which no more decoration adheres, is situated on the winding-up roller 14.

FIG. 2 shows the relationship between the object 2 to be printed and the film 1, in a three-dimensional representation. The situation shown in FIG. 2 corresponds to the situation of the object 2 after passing the detaching roller 9 from FIG. 1. The object 2 has two sides 2a and 2b to be printed. After passing the detaching roller 9 according to FIG. 1, a first part of the decoration 1a situated on the film 1 has been applied to the first side 2a of the object 2 with the aid of the release technique. Subsequently, the second part 1b of the film 1 is adapted, as illustrated by the arrow, to the second side 2b of the object 2 with the aid of the adapting roller 17 from FIG. 1. In the present embodiment according to FIG. 2, the part of the film 1b is bent laterally downwards by the adapting roller and adapted to the side 2b.

FIG. 3 shows a more detailed schematic view from above of the device for applying decoration, which adheres to a film, to a second side of an object. The object 2′, 2″ to be printed passes the adapting roller 17 after having been printed with decoration on the first side. As can be seen in FIG. 3, the part 1b of the film 1′ projects laterally beyond the object 2′ to be printed before passing the adapting roller 17. The decoration, situated on the side 1a, of the film 1′ has already been applied with the aid of the release technique to the first side 2a of the object 2′ to be printed. With the aid of the adapting roller 17, the part 1b of the film 1′ is adapted to the second side 2b of the object 2′ to be printed. This is effected by folding the part 1b laterally downwards. Subsequently, the object 2′ to be printed is fed with the film 1′ to the detaching roller 12. A counter-roller (not shown) can support the object 2′, 2″ on the side 2c.

As already described with reference to FIG. 1, the detaching roller 12 is heated with the aid of five infrared radiators 13, so that the decoration situated on the side 1b of the film 1′ can be detached by the release technique from the film 1′ onto the side 2b of the object 2″ to be printed. Subsequently, the film 1″, which has no more decoration on its surface, is conveyed out of the device, as indicated by the arrow.

According to the invention, it is thus possible to print multidimensional geometries, for example two sides of a panel, with decoration with the aid of only one film. According to the prior art, at least two films are required to print two sides of a panel. Furthermore, it is advantageous in the case of the present invention that no adhesive is necessary for printing the object. The film does not crease, blister and shrink, so that high throughput speeds of the film are possible. In the case of the present invention a film width of 3 cm to 60 cm can be processed. In the case of known devices, only film widths up to a maximum of 10 cm are technically possible. Thus, a plurality of sides of ail object can also be printed with one film. With the embodiment according to the invention, a throughput speed of the film through the device of 5 to 45 m/min can be achieved.

1-16. (canceled)

17. Device for applying decoration, which adheres to a film (1.), to at least two sides of a multidimensional object (2), comprising:
means (9, 10) for detaching parts of the decoration from the film (1) onto a first side (2a) of the object;
means (17) for adapting the film (1) to a second side (2b) of the object, the means for adapting being arranged, in the running direction of the film (1), following the means (9, 10) for detaching parts of the decoration from the film (1) onto a first side (2a) of the object; and
means (12, 13) for detaching parts of the decoration from the film (1), adapted to the second side (2b) of the object, onto the second side (2b) of the object.

18. The device of claim 17, in which the means (12, 13) for detaching parts of the decoration from the film (1) adapted to the second side (2b) of the object are movable in three directions (120, 12b, 12c).

19. The device of claim 17, in which the means (12, 13) for detaching parts of the decoration from the film (1) adapted to the second side (2b) of the object have a profiled detaching roller (12) for detaching the decoration from the film (1) onto the object (2) and means for heating the detaching roller (13).

20. Device for applying decoration, which adheres to a film (1), to at least a second side (2b) of a multidimensional object (2), parts of the decoration having already been applied to a first side (2a) of the object, comprising:
means (17) for adapting the film (1) to a second side (2b) of the object; and
means (12, 13) for detaching parts of the decoration from the film (1), adapted to the second side (2b) of the object, onto the second side (2b) of the object, wherein said means (17) for adapting the film (1) are arranged, in the direction of movement of the film, before the means (12, 13) for detaching.

21. The device of claim 20, in which the means (12, 13) for detaching parts of the decoration from the film (1) adapted to the second side (2b) of the object are movable in three directions (120, 12b, 12c).

22. The device of claim 20, in which the means (12, 13) for detaching parts of the decoration from the film (1) adapted to the second side (2b) of the object have a profiled detaching roller (12) for detaching the decoration from the film (1) onto the object (2) and means for heating the detaching roller (13).

23. The device of claim 22, in which in the case of the means for heating the detaching roller (13) the temperature is variably adjustable.

24. The device of claim 22, in which the means for heating the detaching roller (13) have at least one infrared radiator.

25. The device of claim 22, in which the means for heating the detaching roller (13) are arranged over an area of the surface of the detaching roller (12) which is defined by a circular arc of the detaching roller with a central angle of at least 160° and the width of the detaching roller (12).

26. The device of claim 22, in which the detaching roller (12) includes silicone at least at the surface.

27. The device of claim 22, in which the means (17) for adapting the film to a second side (2b) of the object have at least one adapting roller.

28. A method for applying a decoration, which adheres to a film (1), to a multidimensional object (2), comprising the steps of:
detaching (9, 10) parts of the decoration from the film (1) onto a first side (2a) of the object;
adapting (17) the film (1) to a second side (2b) of the object; and
detaching (12, 13) parts of the decoration from the film (1), adapted to the second side (2b) of the object, onto the second side (2b) of the object.

29. The method of claim 28, in which the detaching (12, 13) of parts of the decoration from the film (1) adapted to the second side (2b) of the object is effected with the aid of at least one profiled detaching roller (12) which is movable in three directions (12a, 12b, 12c).

30. The method of claim 28, further including the steps of heating (13) a profiled detaching roller (12) and detaching the decoration from the film (1) onto the object (2) with the aid of the profiled detaching roller (12).

31. A method for applying decoration, which adheres to a film (1), to at least a second side (2b) of a multidimensional object (2), parts of the decoration having already been applied to a first side (2a) of the object, the method comprising:
adapting (17) the film (1) to a second side (2b) of the object; and
detaching (12, 13) parts of the decoration from the film (1), adapted to the second side (2b) of the object, onto the second side (2b) of the object.

32. The method of claim 31, in which the detaching (12, 13) of parts of the decoration from the film (1) adapted to the second side (2b) of the object is effected with the aid of at least one profiled detaching roller (12) which is movable in three directions (12a, 12b, 12c).

33. The method of claim 31, further including the steps of heating (13) a profiled detaching roller (12) and detaching the decoration from the film (1) onto the object (2) with the aid of the profiled detaching roller (12).

34. The method of claim 33, further comprising variably adjusting the temperature at which the profiled detaching roller (12) is heated.

35. The method of claim 31, in which the detaching roller (12) is heated with the aid of at least one infrared radiator (13).

36. The method of claim 35, in which the detaching roller (12) is heated over an area of the surface of the detaching roller (12) which is defined by a circular arc of the detaching roller with a central angle (of at least 160° and the width of the detaching roller (12).
